(19) United States
(12) Patent Application Publication
(10) Pub. No.: US 2004/0050275 A1
(43) Pub. Date: Mar. 18, 2004

(54) Printing unit

(76) Inventor: Bernd Kurt Masuch, Kurnach (DE)

Correspondence Address: Douglas R Hanscom, Jones Tullar & Cooper, Eads Station, PO Box 2266, Arlington, VA, 22202, US

(21) Appl. No.: 10/380,175

(22) PCT Filed: Sep. 17, 2001
(86) PCT No.: PCT/DE01/03562

(30) Foreign Application Priority Data
Sep. 20, 2000 (DE) 10046371.1
Sep. 20, 2000 (DE) 10046374.6

(51) Int. Cl. B41F 13/004

(52) U.S. Cl. 101/349.1; 101/216

(57) ABSTRACT

A printing unit is comprised of at least three rotating members, such as an impression cylinder, a forme cylinder that cooperates with the impression cylinder in a printing position, and a roller that cooperates with the forme cylinder. The two cylinders and the roller may have a zero rotational speed or a production rotational speed. At least two of the rotating members also have a set-up rotational speed that is different from the zero rotational speed and the production rotational speed of these rotating members.

The invention relates to a printing unit in accordance with the preamble of claims 1, 2 or 27.

A four-cylinder printing unit is known from DE 196 03 663 A1, wherein the two transfer cylinders which cooperate with each other are fixedly coupled to each other and can be selectively driven by the drive mechanism of one or both associated forme cylinders, or via a transverse shaft which can be connected to the motors. In one mode of operation, one of the forme cylinders can be stopped for a plate change, while the associated transfer cylinder continues to run synchronously with the second forme cylinder.

In the same way a five-cylinder printing unit in DE 197 32 330 A1 has a mode of operation, wherein one of the forme cylinders can be stopped for a plate change, while the associated transfer cylinder is either also stopped or is rotatable together with the forme cylinder independently of the remaining three cylinders.

EP 0 997 273 A2 discloses a mode of operation of a four-cylinder printing unit wherein a forme cylinder is moved away from the remaining cooperating cylinders. In one example, the moved-away forme cylinder can be rotated by a drive motor, and in another example by an auxiliary motor.

The object of the invention is based on providing a printing unit.

In accordance with the invention, this object is attained by means of the characteristics of claims 1, 2 or 27.

The advantages which can be obtained by means of the invention reside in particular in that a large operational diversity and variability of a printing unit or a cylinder assembly is created.

For example, it is possible in this way to move cylinders or groups of cylinders independently of each other at different rotational speeds, or also directions of revolutions which is required, for example, when drawing in a paper web, or in the course of independent inking or washing of rollers and cylinders. In particular, different actions when setting up at set-up rotational speeds, or speeds different from the stop (zero rotational speed), or the production rotational speed for the individual cylinder types are therefore possible next to each other and with a paper web running or stopped.

The simultaneous meeting of several different demands made on different components of a printing group or a printing unit is particularly advantageous. For one, the operational modes contribute to time savings and therefore to a lowering of the production costs, and furthermore make possible the performance of various set-up operations at production speed or draw-in speed of the running paper web. A flying plate change for single- or doubled-sided imprint operations is possible. For example, in advantageous operational states a printing forme is changed or pre-inked, while the associated steel cylinder continues to rotate at production speed, or washing, pre-inking or also a change of the dressing takes place.

In particular in connection with printing units which have a counter-pressure cylinder which is embodied as a steel cylinder, for example, various options for setting-up the cylinders without mutual interference arise while the paper web, for example, continues to be imprinted at the production rotational speed (flying plate change/imprint operation), is drawn in at draw-in speed (production start), or is stopped (set-up operation). Together with the modes of operation, or operational states, these printing units permit the guidance of the paper web at draw-in speed or production speed while set-up work can take place at a forme cylinder. In the same way the modes of operation permit the performance of set-up work, for example washing and/or change of dressings or printing formes, pre-inking or dry running, i.e. the removal of ink from the cylinders, while the paper web is stopped and without it being negatively affected.

Because of flexibility and savings of time, as well as of waste, the operational states are of great importance in the course of fitting prior to start-up, or at the end of the printing operation. For example, the forme cylinder and the inking roller can simultaneously pass through different set-up programs.

The independent operation of the rollers for ink application assigned to the forme cylinders is also advantageous. For example, washing or pre-inking takes place regardless of the rotational speed and the direction of rotation and while the forme cylinder also passes through a set-up program.

Exemplary embodiments of the invention are represented in the drawings and will be explained in greater detail in what follows.

Shown are in:

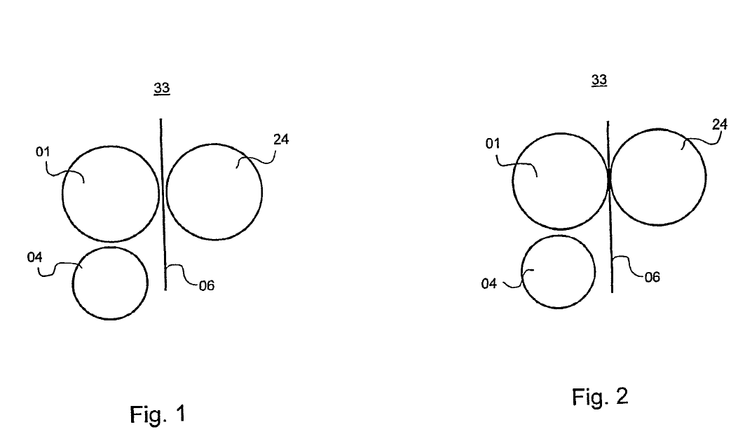

FIG. 1, a schematic lateral view of a two-cylinder printing unit with a roller,

FIG. 2, a schematic lateral view of a two-cylinder printing unit with the roller moved away,

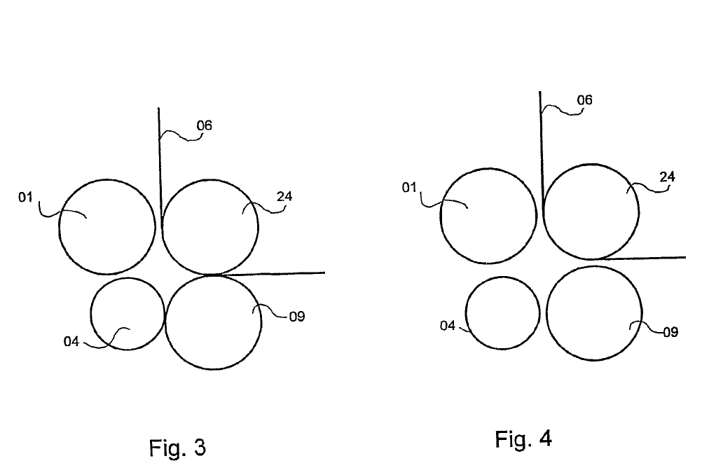

FIG. 3, a schematic lateral view of a two-cylinder printing unit with a roller and an additional forme cylinder,

FIG. 4, a schematic lateral view of a two-cylinder printing unit with an additional forme cylinder.

A printing unit of a printing press, in particular a rotary printing press, has a first cylinder 01, for example a forme cylinder 01. The forme cylinder 01 cooperates via a web 06 with a counter-pressure cylinder 24, for example a steel cylinder 24, and can be placed against or removed from the latter. In a first group of exemplary embodiments, the forme cylinder 01, together with the counter-pressure cylinder 24, constitutes a two-cylinder printing unit 33, for example a printing group for rotogravure or letterpress printing, in particular a flexographic printing group 33.

The forme cylinder 01 can be rotated independently of the counter-pressure cylinder 24, i.e. as a function of the operational state it rotates at times at rotational speeds and/or directions of rotation which are different from the counter-pressure cylinder 24. The counter-pressure cylinder 24 also rotates independently of the forme cylinder 01 at times.

In what follows, the operational states are defined by means of rotational speed or effective circumferential speed on the surfaces, called “speeds” for short in what follows. The operational states mentioned by means of the term “rotational speed” are to be applied in the same way to the term “speed”.

The forme cylinder 01 can take up one or several of the following operational states: it can be stopped, i.e. rotate at a rotational speed “zero” NFZ, but it can also rotate at a production rotational speed PFZ or a set-up rotational speed RFZ which, as a rule, is different from the stopped state NFZ and the production rotational speed PFZ.

The set-up rotational speed RFZ in turn can be a rotational speed DWFZ for a change of the printing forme, a rotational speed VEFZ for pre-inking, or a rotational speed WFZ for washing. A further set-up rotational speed RFZ can also be a rotational speed TFFZ for dry running, i.e. the ink removal from the forme cylinder 01 on the web 06, or a rotational speed EFZ for drawing in the web 06. In a case of a direct image transfer to the surface of the forme cylinder 01 or onto the printing forme on the forme cylinder 01, the set-up rotational speed RFZ can also represent a rotational speed BBFZ for image transfer.

The production rotational speed PFC for the forme cylinder for a double circumference lies, for example, between 20,000 and 50,000 revolutions per hour (r/h), preferably between 35,000 to 45,000 r/h.

The rotational speed VEFZ characteristic for pre-inking the forme cylinder 01 for example lies in the range between 6,000 and 12,000 r/h.

For washing the forme cylinder 01, the rotational speed WFZ for example lies in the range between 200 to 1,000 r/h, in particular between 300 and 800 r/h.

The rotational speed EFZ, for example of the forme cylinder 01 turning along for drawing in the web 06 lies between 600 and 2,000 r/h, for example, in particular 300 to 800 r/h, which approximately corresponds to a draw-in speed of the web 06 between 6 to 30 m/min, in particular 6 to 12 m/min.

For the automatic change of the printing forme, the rotational speed DWFZ can lie between 300 r/h and 2,000 r/h, in particular between 300 r/h and 1,000 r/h, wherein as a rule a reversal of the direction of rotation takes place during the changing process. However, the rotational speed DWFZ can also lie between 120 and 300 r/h during a so-called tip operation. With a direct image transfer to the print forme or the outer cylinder surface of the forme cylinder 01, for example by means of laser(diodes), the rotational speed BBFZ of the forme cylinder 01 as a rule lies above the production rotational speed PFZ, for example above 50,000 r/h, in particular above 70,000 r/h for web-fed printing presses, and above 5,000 r/h, in particular between 5,000 and 30,000 r/h, for sheet printing presses.

The rotational speed TFFZ of the forme cylinder 01 for dry running, i.e. ink removal from the forme cylinder 01, lies between 2,000 and 4,000 r/h.

The rotational speeds mentioned preferably relate to forme cylinders 01 of a double circumference, i.e. to cylinders 01 on whose circumference two printing forms can be fastened one behind the other in the circumferential direction. The circumferences for this are a function of the format and lie for example between 900 mm and 1,300 mm. The rotational speeds of the forme cylinder 01 would have to be doubled in case of the use of cylinders 01 of a single circumference. This correspondingly applies to printing groups, wherein a forme cylinder 01 of single circumference cooperates with a counter-pressure cylinder 24 of twice the circumference.

For one or several of the rotational speed ranges of the forme cylinder 01 mentioned, left or right directions of rotation are possible. These directions of rotation are defined in the subsequent drawing figures representing lateral views of the cylinders 01.

The mentioned operational states, as well as preferred rotational speeds, should also be applied to further forme cylinders added in the course of the description.

The inking roller 04, which is embodied as a screen or anilox roller 04, or as a rubber-coated ink application roller 04, can also either be stopped, i.e. it either rotates at a rotational speed “zero” NW, or at a production rotational speed PW, or at a set-up rotational speed RW. The set-up rotational speed RW can be a rotational speed VEW for pre-inking, a rotational speed WW for washing, or a rotational speed WLW for the continued running of the inking roller 04.

The preferred rotational speed ranges of the inking roller 04 are a function of the printing process and/or the configuration of the printing unit, or of the inking system.

In what follows, a differentiation is to be made between a simple rubber-coated ink application roller 04, an anilox roller 04 or screen roller 04, as well as a screen roller 04 of twice the circumference. The inking roller embodied as a simple rubber-coated ink application roller 04 preferably has approximately one-third the circumference of a forme cylinder 01 of double circumference. A screen roller 04 directly cooperating with the forme cylinder 01 can have the circumference of a forme cylinder 01 of single circumference or, in particular in case of letterpress or flexographic printing, of a forme cylinder 01 of twice the circumference.

For example, the production rotational speed PW lies between 40,000 and 100,000 r/h for the anilox rollers 04 or screen rollers 04 of single circumference directly cooperating with the forme cylinder 01, and between 60,000 and 150,000 r/h in the case of the ink application roller 04. The production rotational speed PW of the screen roller 04 of twice the circumference lies between 20,000 and 50,000 r/h.

The rotational speed VEW for pre-inking the inking roller 04 lies between 12,000 to 24,000 r/h, for example, in the case of the anilox roller 04 or the screen roller 04 of single circumference, and between 18,000 and 36,000 r/h in the case of an ink application roller 04.

For washing the inking roller 04, the rotational speed WW for example lies between 600 and 1,600 r/h in the case of the anilox roller 04 or the screen roller 04 of single circumference, and between 900 and 2,400 r/h in the case of an ink application roller 04.

For continued running of the inking roller 04 to counter the drying of the ink, the rotational speed WLW preferably lies between 3,000 and 6,000 r/h for the screen roller 04 of twice the circumference, between 6,000 and 12,000 r/h for the screen roller 04 of single circumference, and between 9,000 and 18,000 r/h for the ink application roller 04.

As already mentioned above, the mentioned operational states are also defined by effective circumferential speeds, speeds for short, of the rotating bodies.

The production speed PFZ of the forme cylinder 01 lies between 6.4 and 16 m/s, for example, in particular between 11 and 15 m/s.

The speed PWFZ of the forme cylinder 01 for the automated changing of the printing forme lies between 0.32 and 0.64 m/s, for example. For pre-inking the printing forme, the speed VEFZ of the forme cylinder 0.1 lies, for example, between 1.9 and 3.9 m/s, while for washing of the printing forme WFZ it lies between 0.06 and 0.32 m/s, for example, in particular between 0.10 and 0.26 m/s. For dry running TTFZ of the printing forme, the speed of the forme cylinder 01 lies, for example, between 0.64 and 1.3 m/s. As a rule, the speed of the forme cylinder 01 for image transfer BBFZ is greater than 16 m/s, in particular greater than 22 m/s for web-fed printing presses, and for sheet-fed printing presses greater than 1.6 m/s, in particular between 1.6 and 9.6 m/s. For drawing in the web 06, the speed EFZ of the forme cylinder 01 lies for example between 0.10 and 0.50 m/s, in particular between 0.10 and 0.2 m/s.

The speeds of the inking roller 04 in the operational states where it is placed against the forme cylinder 01 are based on the speed of the latter, so that for example the production speed PW of the inking roller 04 also lies in the range between 6.4 and 16 m/s, in particular between 11 and 15 m/s. If the inking roller 04 is embodied as a screen roller 04, its circumference can then approximately correspond to the circumference of a forme cylinder 01 of single circumference, for example. If the circumference of the screen roller 04 has been selected to be greater, for example between 1.0 and 1.2 m, the above mentioned rotational speeds PW should be selected to be less. This correspondingly applies in case the inking roller 04 is embodied as an ink application roller 04, wherein the rotational speed to be selected is again a function of the inking rollers 04, which for example lies between 0.35 and 0.5 m.

For pre-inking, the speed of the inking roller 04 lies for example between 1.9 to 4.0 m/s, and for washing between 0.08 and 0.3 m/s. For continued running, the speed of the inking roller 04 lies for example between 0.95 and 1.95 m/s.

In case where the circumference of the screen roller 04 lies in the lower circumferential range or below, such as is advantageous for example in case of a double-sized forme cylinder 01 during direct printing operations, in an advantageous embodiment variation the above mentioned ranges of the rotational speeds for the screen roller 04 should be increased by the appropriate rotational speed, for example by 0 to 30%, in particular by 10 to 20%, so that the advantageous range for the speed is approximately maintained.

Suitable, or desired rotational speeds for the rotating bodies 01, 04 mentioned, which are embodied as cylinders 01 and rollers 04, can be determined by means of the advantageous speeds, if the effective circumferences for various diameters are known.

In the drawing figures, the rollers 04 are generalized and represented with a uniform diameter for the sake of simplicity. The operational states are described by means of rotational speeds in the exemplary embodiments. However, the same exemplary embodiments can also be read from the speeds characterizing the operational speeds.

The steel cylinder 24 can either be stopped, i.e. it rotates at a rotational speed “zero” NSZ, or at a production rotational speed PSZ or a set-up rotational speed RSZ. The set-up rotational speed RSZ of the steel cylinder 24 can be a rotational speed AWSZ for changing a cover or dressing, a rotational speed ESZ for drawing in the web 06, or a rotational speed WSZ for washing the steel cylinder 24, a rotational speed TFSZ for dry running, i.e. the ink removal from the forme cylinder 01 on the web 06.

The production rotational speed PSZ of the steel cylinder 24 lies for example between 20,000 and 50,000 r/h, preferably at 35,000 to 45,000 r/h.

For changing a dressing, for example a foil, on the steel cylinder 24, the rotational speed AWSZ lies between 300 and 2,000 r/h, in particular between 300 and 1,000 r/h.

The rotational speed ESZ of the steel cylinder 24 for drawing in the web 06 for example lies between 300 and 2,000 r/h, in particular 300 to 800 r/h.

For washing the steel cylinder 24, the rotational speed WSZ lies for example between 200 and 1,000 r/h, in particular between 300 and 800 r/h.

The rotational speed TFSZ for dry running lies for example between 2,000 and 4,000 r/h, in particular between 2,000 and 3,000 r/h, for the steel cylinder 24.

As already explained above for the forme cylinder 01, the mentioned rotational speed ranges apply to cylinders 01, 24 of double circumference. When employing a steel cylinder 24 of single circumference, the rotational speeds mentioned approximately double for the steel cylinder 24.

In case of a steel cylinder 24 of triple circumference which, for example, cooperates with one or two forme cylinders 01 of double circumference, in an advantageous manner the above mentioned rotational speeds of the steel cylinder 24 should be multiplied by approximately ⅔.

In what was just mentioned, the various operational states are also taking the place of operational states defined by the rotational speed or circumferential speeds, speeds for short.

The production speed PSZ of the steel cylinder 24 for example lies between 6.4 and 16 m/s, in particular between 11 and 15 m/s. The speed AWSZ of the steel cylinder 24 for changing the dressing lies for example between 0.32 and 0.64 m/s, in particular between 11 and 15 m/s. The speed SWSZ of the steel cylinder 24 for changing the dressing lies for example between 0.32 and 0.64 m/s, while for washing WSZ of the steel cylinder 24 it lies between 0.06 and 0.32 m/s, for example, in particular between 0.10 and 0.26 m/s. For dry running TFFZ of the forme cylinder 01, the speed of the steel cylinder 24 for example lies between 0.10 and 0.50 m/s. The speed ESZ for draw-in lies, for example, between 0.10 and 0.50 m/s, in particular between 0.10 and 0.2 m/s.

Suitable, or desired rotational speeds for the rotating body 04, embodied as a steel cylinder 04, can be also determined by means of the advantageous speeds, if the effective circumferences for various diameters are known.

What has been said above also applies to directions of rotation, left and right rotation, as well as to the applicability of the rotational speed ranges, for further steel cylinders mentioned in the subsequent description.

In a first exemplary embodiment (FIG. 1), the steel cylinder 24 rotates at the production rotational speed PSZ, for example to the right, while the forme cylinder 01, which has been moved away from the steel cylinder 24, rotates at the set-up rotational speed DWFZ for changing the printing forme, or alternatively at the rotational speed BBFZ for image transfer. The forme cylinder 01 and the associated inking roller 04 are for example moved apart from each other, wherein the inking roller 04 also rotates at one of its set-up speeds RW. However, the inking roller 04 can also be in the stopped state NW.

In the second exemplary embodiment (FIG. 1), the steel cylinder 24 rotates at the set-up rotational speed RSZ, for example at the rotational speed ESZ for drawing in the web 06, while the forme cylinder 01, which is moved away from the steel cylinder 24, is in the stopped state NFZ. The inking roller 04 and the forme cylinder 01 are preferably moved away from each other wherein, for maintaining its surface moist, the inking roller 04 rotates at one of its set-up rotational speeds RW, in particular at the rotational speed WLW for continuing the run at reduced rotational speed.

In a third exemplary embodiment (FIG. 1) the steel cylinder 24 is in the stopped stated NSZ, while the forme cylinder 01, which has been moved away from the steel cylinder 24, rotates at one of its set-up rotational speeds RFZ, for example at the rotational speed DWFZ for changing the printing forme, or alternatively at the rotational speed BBFZ for image transfer. The inking roller 04, which is moved away from the forme cylinder 01, can simultaneously rotate at the set-up rotational speed RW, or can be stopped, i.e. rotate at a rotational speed “zero” NW.

In the fourth exemplary embodiment (FIG. 2), the steel cylinder 24 rotates at one of its set-up rotational speeds RSZ, for example at the rotational speed TFSZ for dry running of the forme cylinder 01, for example turning to the right, while the forme cylinder 01, which is placed against the steel cylinder 24, rotates at one of its set-up rotational speeds RFZ, for example at a rotational speed TFFZ for dry running of the printing forme. The forme cylinder 01 and the associated inking roller 04 are moved away from each other. The inking roller 04 for example also rotates at one of its set-up speeds RW, for example at the rotational speed WW for washing the inking roller 04. However, the inking rollers 04 can already be in the stopped state NW, such as is the case at the end of production, for example.

In a fifth exemplary embodiment (FIG. 1), the inking roller 04 rotates at one of its set-up rotational speeds RW, for example at the rotational speed WLW for further running, for example turning to the right, while the forme cylinder 01, which has been moved away from the steel cylinder 24, rotates at one of its set-up speeds RFZ, for example at its rotational speed DWFZ for changing the printing forme, or alternatively at the rotational speed BBFZ for image transfer. In another embodiment, the steel cylinder 24, and therefore the web 06, is in a stopped state NSZ. If, however, the web 06 is being drawn in while the change of the printing forme takes places, the steel cylinder 24 can rotate at the rotational speed ESZ for drawing in the web 06.

In a second group of exemplary embodiments (FIG. 3), the sixth to the ninth exemplary embodiments, the steel cylinder 24 cooperates with the forme cylinder 01 and the second forme cylinder 09, wherein either both forme cylinders 01, 09, or selectively one of the forme cylinders 01, 09, or none of the forme cylinders 01, 09, can be in contact. For the second forme cylinder 09, together with the steel cylinder 24, all operational states mentioned for the forme cylinder 01 together with the steel cylinder 24 are possible, independently of and parallel with the operational states from the exemplary embodiments seventy to seventy three. The second forme cylinder can have its own inking roller 04, for whose operational states the same applies had been said above. However, in the following examples the two forme cylinders 01, 09 have the inking roller 04 in common.

In the sixth exemplary embodiment (FIG. 3), the steel cylinder 24 and the second forme cylinder 09 placed against the steel cylinder 24 rotate at their respective production rotational speed PSZ, PFZ, but in opposite directions of rotation. The first forme cylinder 01 is moved away from the steel cylinder 24 and rotates at its set-up rotational speed RFZ, for example at the rotational speed DWFZ for changing the printing forme, or alternatively at the rotational speed BBFZ for image transfer. In this case the inking roller 04 is pivoted away from the first forme cylinder 01 and pivoted against the second forme cylinder 09 and rotates at the production rotational speed PW, but opposite the direction of rotation of the second forme cylinder 09. It is of course possible to interchange these processes for the purpose of changing the printing forme on the second forme cylinder 09 while the first forme cylinder 01 prints.

In a seventh exemplary embodiment (FIG. 4), both forme cylinders 01, 09 are moved away from the steel cylinder 24. The steel cylinder 24 rotates at one of its set-up rotational speeds RST, for example at the rotational speed ESZ for drawing in the web 06. At least one of the two forme cylinders 01, 02 rotates for example at one of its set-up rotational speeds RFZ, in particular at the rotational speed DWFZ for changing the printing forme, or alternatively at the rotational speed BBFZ for image transfer. However, in a variation, for guiding the web 06 one of the printing cylinders 01, 09 can rotate along at the rotational speed EFZ for drawing in the web 06. For example, the inking roller 04 rotates at the rotational speed WLW for continued running, or it is in the stopped state NW.

In an eighth exemplary embodiment, the steel cylinder 24 and at least one of the two forme cylinders 01, 09 rotate at one of their set-up rotating speeds RSZ, RFZ, for example at the rotational speed TFFZ, TFSZ for dry running, i.e. removing ink from the forme cylinders 01, 09.

In the ninth exemplary embodiment, the steel cylinder 24 and at least one of the forme cylinders 01, 09 is in the stopped state NSZ, NFZ, while the inking roller 04 rotates at one of its set-up rotational speeds RW, in particular at the rotational speed WW for washing the inking roller 04.

The embodiment of the inking roller 04 as a screen roller 04 is advantageous in the exemplary embodiment one to nine, wherein it is for example 10 to 20% smaller than the cooperating forme cylinder 01, 09 of twice the circumference. The screen roller 04 has a circumference of approximately 0.96 m, and the forme cylinder 01, 09 a circumference of approximately 1.2 m, for example.

It is advantageous for the exemplary embodiments one to nine, in particular six to nine, if the steel cylinder 24 and the inking roller 04 are stationarily arranged, while the forme cylinder(s) 01, 09 is/are embodied so it/they can be placed against the steel cylinder 24 and the inking roller 04, for example by means of pivoting.

It is of advantage in the described exemplary embodiments if at least the cylinders 01, 09, which rotate differently in the exemplary embodiments, in particular at different rotational speeds, are driven by their own drive motor. In a preferred embodiment, however, all cylinders 01, 09 of the described printing units can be individually driven by their own drive motors without a driven coupling to another cylinder 01, 09 or inking system. In that case the drive motors then drive the respective cylinder 01, 09, or the inking system, during set-up operations, as well as during production.

The employment of position-regulated and/or rpm-regulated electric motors is of particular advantage. This also applies to the drives of the rollers 04, which can either have their own drive motor, or the inking system containing the roller 04 has a drive motor, which is independent of the cylinders 01, 09.

List of Reference Numerals

01 Cylinder, first, forme cylinder, rotating body

02 -

03 -

04 Roller, inking roller, ink application roller, screen roller, anilox roller, rotating body

05 -

06 Web, web of material to be imprinted, paper web

07 -

08 -

09 Cylinder, forme cylinder, second, rotating body

10 to 23 -

24 Cylinder, counter-pressure cylinder, satelitte cylinder, steel cylinder, first, rotating body

25 to 32 -

33 Two-cylinder printing unit, flexographic print system

Rotational Speeds

| | |
|---|---|
| PFZ | Production rotational speed, production rotational |
| | speed of the forme cylinder |
| PSZ | Production rotational speed, production rotational |
| | speed of the counter-pressure or steel cylinder |
| PW | Production rotational speed, production rotational |
| | speed of the roller |
| RFZ | Set-up rotational speed, set-up rotational speed of |
| | the forme cylinder |
| RSZ | Set-up rotational speed, set-up rotational speed of |
| | the counter-pressure or steel cylinder |
| RW | Set-up rotational speed, set-up rotational speed of |
| | the roller |
| NFZ | Forme cylinder stopped, rotational speed zero, |
| | speed zero |
| NSZ | Counter-pressure or steel cylinder stopped, |
| | rotational speed zero, speed zero |
| NW | Roller stopped, rotational speed zero, speed zero |
| DWFZ | Rotational speed, speed of the forme cylinder for |
| | changing the printing forme |
| BBFZ | Rotational speed, speed of the forme cylinder for |
| | image transfer |
| VEFZ | Rotational speed, speed of the forme cylinder for |
| | pre-inking the forme cylinder |
| WFZ | Rotational speed, speed of the forme cylinder for |
| | washing the forme cylinder |
| TFFZ | Rotational speed, speed of the forme cylinder for |
| | the dry running of the forme cylinder |
| EFZ | Rotational speed, speed of the forme cylinder for |
| | drawing in a web |
| AWSZ | Rotational speed, speed of the counter-pressure or |
| | steel cylinder for changing the dressing, the |
| | cover |
| WSZ | Rotational speed, speed of the counter-pressure or |
| | steel cylinder for washing the transfer cylinder |
| ESZ | Rotational speed, speed of the counter-pressure or |
| | steel cylinder for drawing in a web |
| TFSZ | Rotational speed, speed of the counter-pressure or |
| | steel cylinder for dry running |
| VEW | Rotational speed, speed of the roller for pre- |
| | inking |
| WW | Rotational speed, speed of the roller for washing |
| WLW | Rotational speed, speed of the roller for continued |
| | running |

1. A printing unit with at least three rotating bodies (01, 09, 24), which cooperate in pairs in a print-on position, namely a satellite cylinder (24) and at least one forme cylinder (01, 02) which cooperates in a print-on position with the satellite cylinder (24), as well as at least one inking roller (04) which cooperates in a print-on position with the forme cylinder (01, 09), characterized in that at least two of the three rotating bodies (01, 09, 24) simultaneously have a set-up rotational speed (RFZ, RSZ, RW), which differs from a respective production rotational speed (PFZ, PSZ, PW) and from the rotational speed zero (NFZ, NSZ, NW).

2. A printing unit with at least two cylinders (01, 09, (24), namely a satellite cylinder (24) and at least one forme cylinder (01, 09), which cooperates with the satellite cylinder (24) in a print-on position, as well as an inking roller (04), which cooperates with the forme cylinder (01, 09) in a print-on position, characterized in that at least one of the cylinders (01, 09, 24) and at least the inking roller (04), or at least two of the cylinders (01, 09, 24) simultaneously have a set-up rotational speed (RFZ, RSZ, RW), which differs from the respective production rotational speed (PFZ, PSZ, PW) and from the rotational speed zero (NFZ, NSZ, NW).

3. The printing unit in accordance with claim 1 or 2, characterized in that a second forme cylinder (01, 09) can be placed against the satellite cylinder (24).

4. The printing unit in accordance with claim 3, characterized in that the two forme cylinders (01, 02) of the printing unit, which are assigned to the satellite cylinder (24), have a common inking roller (24) which selectively cooperates with one of the two forme cylinders (01, 09).

5. The printing unit in accordance with one of claims 1 to 3, characterized in that at least one forme cylinder (01, 09) is at set-up rotational speed (RFZ), while the satellite cylinder (24) is at production rotational speed (PSZ).

6. The printing unit in accordance with one of claims 1 to 3, characterized in that at least one forme cylinder (01, 09) is at set-up rotational speed (RFZ), while the satellite cylinder (24) is at set-up rotational speed (RSZ).

7. The printing unit in accordance with one of claims 1 to 3, characterized in that at least one forme cylinder (01, 09) is at set-up rotational speed (RFZ), while the satellite cylinder (24) is at the rotational speed zero (NSZ).

8. The printing unit in accordance with one of claims 1 to 3, characterized in that at least one forme cylinder (01, 09) is at the rotational speed zero (NFZ), while the satellite cylinder (24) is at set-up rotational speed (RSZ).

9. The printing unit in accordance with one of claims 1 to 8, characterized in that the inking roller (04) is at set-up rotational speed (RW).

10. The printing unit in accordance with one of claims 1 to 8, characterized in that the inking roller (04) is at the rotational speed zero (NW).

11. The printing unit in accordance with one of claims 1 to 8, characterized in that the set-up rotational speed (RFZ) of the forme cylinder (01, 09) is equal to a rotational speed (DWFZ) for a change of a printing forme on the forme cylinder (01, 09).

12. The printing unit in accordance with one of claims 1 to 8, characterized in that the set-up rotational speed (RFZ) of at least one forme cylinder (01, 09) is equal to a rotational speed (BBFZ) for an image transfer to one printing forme on the forme cylinder (01, 09) or a surface area of the forme cylinder 01, 09).

13. The printing unit in accordance with one of claims 1 to 8, characterized in that the set-up rotational speed (RFZ) of the forme cylinder (01, 09) is equal to a rotational speed (VEFZ) for the pre-inking of the forme cylinder (01, 09).

14. The printing unit in accordance with one of claims 1 to 8, characterized in that the set-up rotational speed (RFZ) of the forme cylinder (01, 09) is equal to a rotational speed (EFZ) for drawing in a web (06).

15. The printing unit in accordance with one of claims 1 to 8, characterized in that the set-up rotational speed (RFZ) of the forme cylinder (01, 09) is equal to a rotational speed (TFFZ) for the dry running of the forme cylinder (01, 09).

16. The printing unit in accordance with one of claims 1 to 8, characterized in that the set-up rotational speed (RSZ) of the satellite cylinder (24) is equal to a rotational speed (AWSZ) for changing a dressing on the satellite cylinder (24).

17. The printing unit in accordance with one of claims 1 to 8, characterized in that the set-up rotational speed (RSZ) of the satellite cylinder (24) is equal to a rotational speed (ESZ) for drawing in a web (06).

18. The printing unit in accordance with claim 9, characterized in that the set-up rotational speed (RW) of the inking roller (04) is equal to a rotational speed (VEW) for pre-inking the inking roller (04).

19. The printing unit in accordance with claim 9, characterized in that the set-up rotational speed (RSZ) of the inking roller (04) is equal to a rotational speed (WLW) for continued running of the inking roller (04).

20. The printing unit in accordance with claim 9, characterized in that the set-up rotational speed (RSZ) of the inking roller (04) is equal to a rotational speed (WW) for washing the inking roller (04).

21. The printing unit in accordance with claim 1 or 2, characterized in that each of the cylinders (01, 09) is driven by its own drive motor.

22. The printing unit in accordance with one of claims 1 to 3, characterized in that the roller (04) is driven by a drive motor which is independent of the cylinders (01, 09, 24).

23. The printing unit in accordance with one of claims 21 or 22, characterized in that the drive motors are embodied as position-regulated electric motors.

24. The printing unit in accordance with one of claims 21 or 22, characterized in that the drive motors are embodied as rpm-regulated electric motors.

25. The printing unit in accordance with claim 1 or 2, characterized in that the production rotational speed (PFZ, PSZ, PW) can be determined by means of a desired circumferential speed (PFZ, PSZ, PW).

26. The printing unit in accordance with claim 1 or 2, characterized in that the set-up rotational speed (RFZ, RSZ, RW) can be determined by means of a desired circumferential speed RFZ, (RSZ, RW).

27. A printing unit with at least three rotating bodies (01, 09, 24), which cooperate in pairs in a print-on position, namely a satellite cylinder (24) and at least one forme cylinder (01, 02) which cooperates in a print-on position with the satellite cylinder (24), as well as at least one inking roller (04) which cooperates in a print-on position with the forme cylinder (01, 09), characterized in that two of the three rotating bodies (01, 09, 24) simultaneously have a set-up speed (RFZ, RSZ, RW), which differs from a respective production speed (PFZ, PSZ, PW) and from the speed zero (NFZ, NSZ, NW).
